(19) United States
(12) Patent Application Publication
(10) Pub. No.: US 2005/0218805 A1
(43) Pub. Date: Oct. 6, 2005

(54) Plasma display panel and plasma display

(76) Inventors: Masatoshi Kitagawa, Hirakata-shi (JP); Masaharu Terauchi, Nara-shi (JP); Yukihiro Morta, Hirakata-shi (JP); Shinichiro Hashimoto, Toyonaka-shi (JP)

Correspondence Address: SNELL & WILMER LLP, 1920 MAIN STREET, SUITE 1200, IRVINE, CA, 92614-7230, US

(21) Appl. No.: 10/511,062

(22) PCT Filed: Nov. 28, 2003
(86) PCT No.: PCT/JP03/15213

§ 371 Date: Oct. 12, 2004

(30) Foreign Application Priority Data
Nov. 28, 2002 (JP) 2002-345497
May 12, 2003 (JP) 2003-133077

(51) Int. Cl. H01J 17/49

(52) U.S. Cl. 313/582

(57) ABSTRACT

A plasma display panel in which a plurality of pairs of first and second electrodes are disposed on a first substrate so as to be parallel to each other, a plurality of third electrodes are disposed on a second substrate, and main parts of a plurality of barrier ribs are disposed between adjacent third electrodes, the third electrodes being orthogonal to a longitudinal direction of display electrodes each of which consists of a pair of the first and second electrodes, wherein a plurality of fourth electrodes are fixed to the barrier ribs or areas of a surface of the first substrate facing the barrier ribs so as to be at least in vicinities of areas between adjacent display electrodes, the fourth electrodes being electrically exposed to discharge spaces which are defined by the barrier ribs.

### TECHNICAL FIELD

The present invention relates to a plasma display panel and a plasma display device used as a display device and the like, and more specifically relates to a technique for improving a state of a discharge.

### BACKGROUND ART

In recent years, among display devices used for computers and televisions, plasma display panels (hereinafter called “PDPs”) are drawing attentions as display devices that can have large screens but can be thin and lightweight.

The PDPs are display devices which realize a color display by irradiating phosphors (of red, green and blue) with ultraviolet rays, which is generated when a discharge of plasma is caused in a gas, so as to obtain visible light.

When the above discharge of plasma is caused, an anomalous discharge between adjacent cells, which is a so-called cross talk, can occur. This cross talk is the cause of anomalous emission of light, which worsens the display quality.

To solve this problem, one of conventional PDPs has barrier ribs which physically isolate cells from other adjacent cells.

FIG. 11 shows an exploded perspective view of a PDP 2000 which has such barrier ribs.

The PDP 2000 has the following configuration. A front plate 1090 and a back plate 1091 are disposed so as to face each other's principal surface. These plates are disposed one on top of another and sealed at peripheral edges of the plates with sealing glass (not shown in the figure) so that a discharge space 1101 is formed between them.

The front plate 1090 includes a front glass substrate 1101, a display electrode 1102, a display electrode 1103, a dielectric layer 1106, and a protective layer 1107.

The front glass substrate 1101 is a substrate of the front plate 1090. The display electrode 1102 and the display electrode 1103 are disposed on the front glass substrate 1101.

The display electrode 1102, the display electrode 1103, and the front glass substrate are coated with the dielectric layer 1106 and the protective layer 1107. The protective layer 1107 is made of magnesium oxide (MgO).

The back plate 1091 includes a back glass substrate 1111, an address electrode 1112, a dielectric layer 1113, a shadow mask 1114 which forms parallel crosses with a bottom, and phosphor layers 1115r; 1115g, and 1115b which are formed on the inside surface of the shadow mask 1114. The phosphor layers 1115r, 1115g, and 1115b correspond to red, green, and blue respectively.

The shadow mask 1114 works as the barrier rib of the PDP, and forms parallel crosses with a bottom as described above. The shadow mask 1114 is made of Invar or the like, having a low expansion rate and flexible workability, and is composed of a parallel part 1114a, which is parallel to the address electrode 1112, an orthogonal part 1114b, which is at right angles to the address electrode 1112, and a plane part 1114c, which has a platy shape and in contact with a dielectric layer 1113.

As shown in FIG. 12A and FIG. 12B, there are narrow gaps between the tops of the orthogonal part 1114b and the front plate 1090 as gas flow paths between cells which are used for releasing an impure gas and filling a discharge gas quickly.

The discharge space 1101 is filled with a discharge gas which is composed of rare gases, such as He, Xe, and Ne.

The vicinity of an area where a pair of the display electrode 1102 and the display electrode 1103 cross one address electrode 107 over the discharge space 1101 corresponds to a cell that contributes to image display.

Note that FIG. 11 shows adjacent cells each of which is divided at its center.

The phosphor layers 1115r, 1115g, and 1115b are formed on the wall surface of the depression part of the shadow mask 1114, except on a center line area 1114d which is in the vicinity of the address electrode 1112.

This makes the shadow mask 1114 exposed to the discharge space 1101.

In the above-described configuration, the shadow mask made from metal intervenes between the display electrode and the address electrode. Therefore, the whole region of the shadow mask inevitably has the same electric potential.

As a result, in the case of performing the address discharge in the normal way for the AC type PDP between the address electrode and one of the display electrodes, an electric field which is generated by the metal shadow mask impedes a charge transfer to the surface of the display electrode in the cell which is to be addressed, and the address discharge becomes difficult.

In other words, the general driving method for AC type PDPs, in which the addressing is performed using the discharge between the display electrode and the address electrode, and a sustain discharge is performed between the pair of the display electrodes for surface discharge, becomes unavailable.

Therefore, the above-described PDP 2000 performs an opposed-discharge type light emission with use of a discharge between the display electrode 1102 or the display electrode 1103 and the address electrode 1112, which is different from the normal surface-discharge type PDPs.

Note that the above-described PDP 2000 is detailed in a document by an academic society (SID 2002: Society for Information Display 2002 International Symposium May 15, 2002).

Also note that there is a conventional AC type PDP which has metal barrier ribs between adjacent display electrodes in different cells (Japanese unexamined patent publication No. 10-302645).

In the PDPS with this configuration, in which the adjacent discharge spaces are substantially isolated from each other by the above-described orthogonal part 1114b between the display electrodes 1102 and 1103, it is hard to cause the address discharge as described above, though the cross talk is less likely to occur between adjacent display electrodes 1102 and 1103.

However, the cross talk infrequently occurs in the conventional PDPS by a charge transfer through narrow gaps provided as gas flow paths. Therefore, further reduction of the cross talk and improvement in luminous efficiency is desired. Furthermore, improvement in the state of the discharge is strongly desired.

### DISCLOSURE OF THE INVENTION

In view of the above demands, the present invention aims to provide a plasma display panel and a plasma display device in which the state of discharger is improved.

The object can be achieved by a plasma display panel in which a plurality of pairs of first and second electrodes are disposed on a first substrate so as to be parallel to each other, a plurality of third electrodes are disposed on a second substrate, and main parts of a plurality of barrier ribs are disposed between adjacent third electrodes, the third electrodes being orthogonal to a longitudinal direction of display electrodes each of which consists of a pair of the first and second electrodes, wherein a plurality of fourth electrodes are fixed to the barrier ribs or areas of a surface of the first substrate facing the barrier ribs so as to be at least in vicinities of areas between adjacent display electrodes, the fourth electrodes being electrically exposed to discharge spaces which are defined by the barrier ribs.

By applying voltages to the fourth electrodes which are disposed in vicinities of areas between adjacent display electrodes, the adjacent display electrodes become electrically, not physically, isolated from each other. In other words, the fourth electrodes work as barriers against charge transfer, which prevent the cross talk.

This improves the state of the discharge, and may also improve the discharge efficiency.

The fourth electrodes may be at a first distance from the first substrate, and fixed to the barrier ribs in such a manner as to be inserted in the barrier ribs or disposed on surfaces of the barrier ribs.

According to the stated construction, the distance between the fourth electrodes and the first substrate can be set freely.

In the case where the fourth electrodes are inserted in the barrier ribs, there is no fourth electrode on top of the barrier ribs. In other words, the first substrate faces the top surfaces of the barrier ribs which can be molded flexibly. Therefore, it becomes easy to create gaps as gas flow paths between the first substrate and the barrier ribs.

This realizes a quick releasing of an impure gas and quick filling of a discharge gas.

The fourth electrodes may be disposed on top of the barrier ribs.

According to the stated construction, the fourth electrodes can be formed on top of the barrier ribs with use of a conventional method for forming barrier ribs.

The plasma display panel may further comprise a plurality of fifth electrodes which are inserted in the barrier ribs at a second distance from the first substrate.

According to the stated construction, more accurate discharge control can be performed when voltages are applied to the fourth electrodes and the fifth electrodes individually.

Sub-parts of the barrier ribs, which bridge adjacent main parts of the barrier ribs, may be substantially orthogonal to the third electrodes, the fourth electrodes may be fixed to the main parts of the barrier ribs, and the fifth electrodes may be fixed to the sub-parts of the barrier ribs.

According to the stated construction, the discharge is caused along at least a part of the barrier ribs. This enables the fourth electrodes and the fifth electrodes to prevent the cross talk which occurs between cells which are adjacent in the direction of the charge transfer.

Sub-parts of the barrier ribs, which bridge adjacent main parts of the barrier ribs, may be substantially orthogonal to the third electrodes.

According to the stated construction, voltage control according to the direction of the charge transfer can be realized as described above.

The object can be achieved by a plasma display device in which a plurality of pairs of first and second electrodes are disposed on a first substrate so as to be parallel to each other, a plurality of third electrodes are disposed on a second substrate, and main parts of a plurality of barrier ribs are disposed between adjacent third electrodes, the third electrodes being orthogonal to a longitudinal direction of display electrodes each of which consists of a pair of the first and second electrodes, wherein a plurality of fourth electrodes are fixed to the barrier ribs so as to be at least in vicinities of areas between adjacent display electrodes, the fourth electrodes being electrically exposed to discharge spaces which are defined by the barrier ribs, and the plasma display device includes a driving circuit for applying a voltage to the fourth electrode or for earthing the fourth electrodes.

By applying voltages to the fourth electrodes which are disposed in vicinity of areas between adjacent display electrodes, the adjacent display electrodes become electrically, not physically, isolated from each other. As a result, the cross talk can be prevented.

In other words, the state of the discharge caused in the PDP can be improved.

The driving circuit may apply positive voltages to the fourth electrodes.

By applying positive voltages to the fourth electrodes which are disposed in vicinities of areas between adjacent display electrodes, the adjacent display electrodes become electrically, not physically, isolated from each other. As a result, the cross talk can be prevented.

The fourth electrodes may be at a first distance from the first substrate, and fixed to the barrier ribs in such a manner as to be inserted in the barrier ribs or disposed on surfaces of the barrier ribs.

According to the stated construction, the distance between the fourth electrodes and the first substrate can be set freely.

The fourth electrodes may be disposed on top of the barrier ribs.

According to the stated construction, the fourth electrodes can be formed on top of the barrier ribs with use of a conventional method for forming barrier ribs.

The driving circuit may apply a first voltage pulse and a second voltage pulse to the first electrodes and the second electrodes respectively, and additionally apply a third voltage pulse to the fourth electrodes.

According to the stated construction, voltages can be applied to fourth electrodes and the fifth electrodes individually, and more accurate discharge control can be performed.

The plasma display device may further comprise a plurality of fifth electrodes which are inserted in the barrier ribs at a second distance from the first substrate, wherein the driving circuit applies a fourth voltage pulse to the fifth electrodes when outputting the first voltage pulse and the second voltage pulse at the same time.

Usually, an AC discharge is caused by applying voltages to the first electrodes and the second electrodes alternately. At that moment, by applying voltages to the fourth electrodes so that the period in which voltage pulses applied to the first electrodes fall down and the period in which voltage pulses applied to the second electrodes rise up overlap each other, the negative charges are inductively accelerated by the fourth electrodes which exist in the vicinity. This realizes a driving with low electric power.

Sub-parts of the barrier ribs, which bridge adjacent main parts of the barrier ribs, may be substantially orthogonal to the third electrodes, the fourth electrodes may be fixed to the main parts of the barrier ribs, and the fifth electrodes may be fixed to the sub-parts of the barrier ribs.

According to the stated construction, the discharge is caused along at least a part of the barrier ribs. As a result, voltage control according to the direction of the charge transfer can be realized.

Sub-parts of the barrier ribs, which bridge adjacent main parts of the barrier ribs, may be substantially orthogonal to the third electrodes.

According to the stated construction, voltage control according to the direction of the charge transfer can be realized as described above.

### BRIEF DESCRIPTION OF THE DRAWINGS

FIG. 1 is a block diagram which shows the overall configuration of a PDP device according to the first embodiment;

FIG. 2 is a perspective view which typically shows the configuration of a panel unit 100 according to the first embodiment;

FIG. 3A and FIG. 3B are cross-sectional views of a panel unit 100 according to the first embodiment;

FIG. 4 is a perspective view which typically shows the configuration of a panel unit 500 according to the second embodiment;

FIG. 5A and FIG. 5B are cross-sectional views of a panel unit 500 according to the second embodiment;

FIG. 6 is a block diagram which shows the overall configuration of a PDP device according to the third embodiment;

FIG. 7 describes a pattern for applying voltage to each electrode according to the third embodiment;

FIG. 8 is a block diagram which shows the overall configuration of a PDP device according to the fourth embodiment;

FIG. 9A and FIG. 9B are cross-sectional views of a panel unit 500 according to the fourth embodiment;

FIG. 10 describes a pattern for applying voltage to each electrode according to the fourth embodiment;

FIG. 11 is an exploded perspective view of a conventional PDP device;

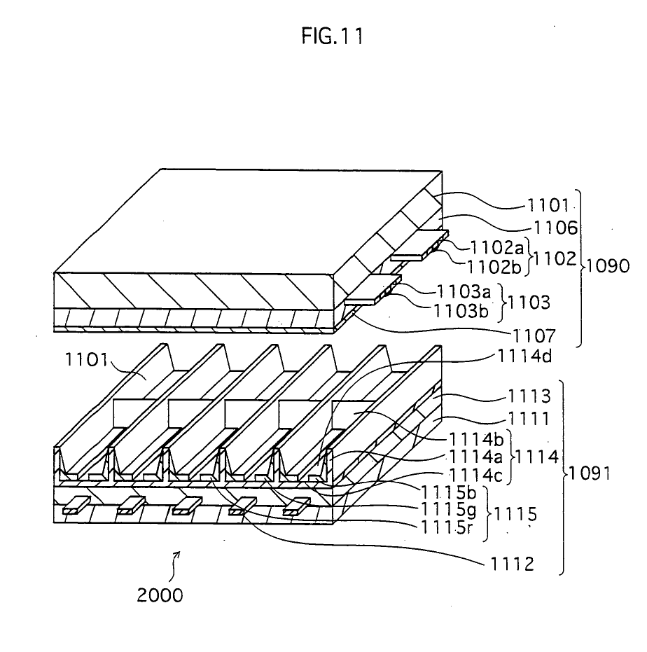

FIG. 12A and FIG. 12B are cross-sectional views of a panel unit in a conventional PDP device.

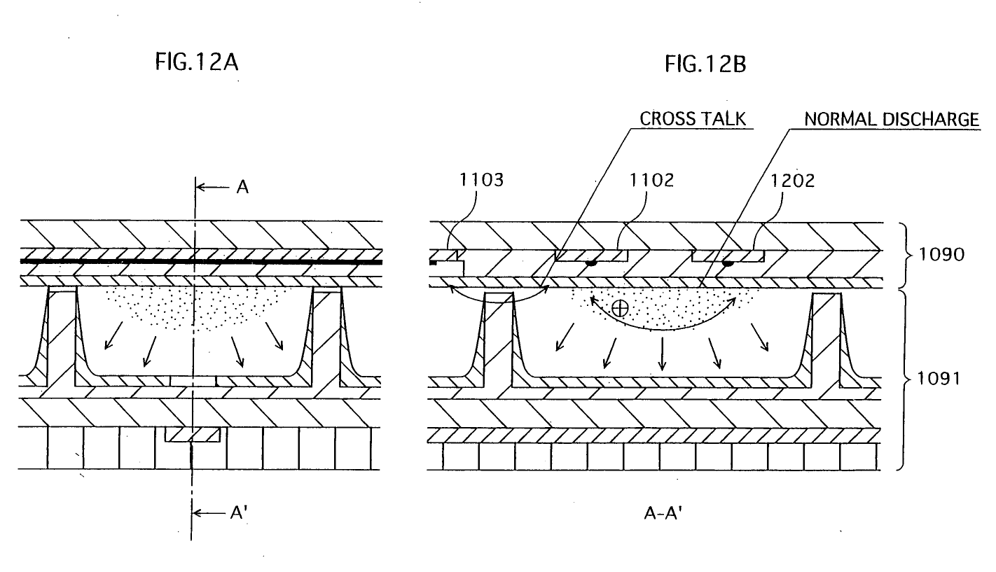

### BEST MODE FOR CARRYING OUT THE INVENTION

The following describes a PDP device and a method for driving the PDP device which are embodiments of the present invention, with reference to the attached figures.

The first embodiment

1. The overall configuration of the PDP device 1000

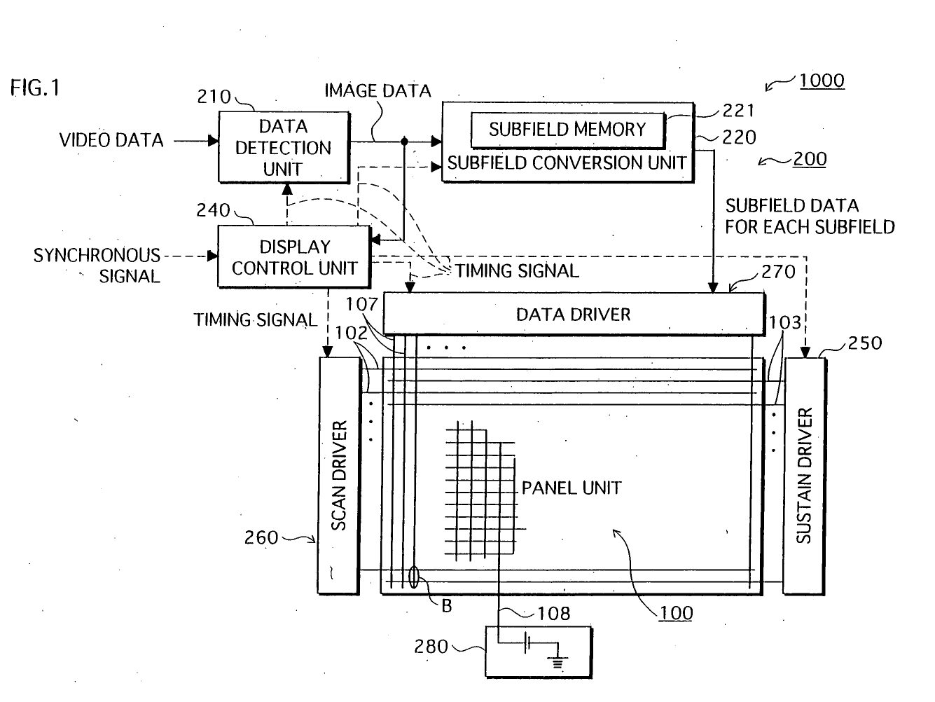

FIG. 1 is a block diagram which shows the overall configuration of the AC type PDP device according to the present invention.

As FIG. 1 shows, The PDP device 1000 includes a panel unit 100 for displaying images, and a display driving unit 200 for driving the panel unit 100 based on the intra-field time division gradation display technique.

1-1. The Structure of the Panel Unit 100

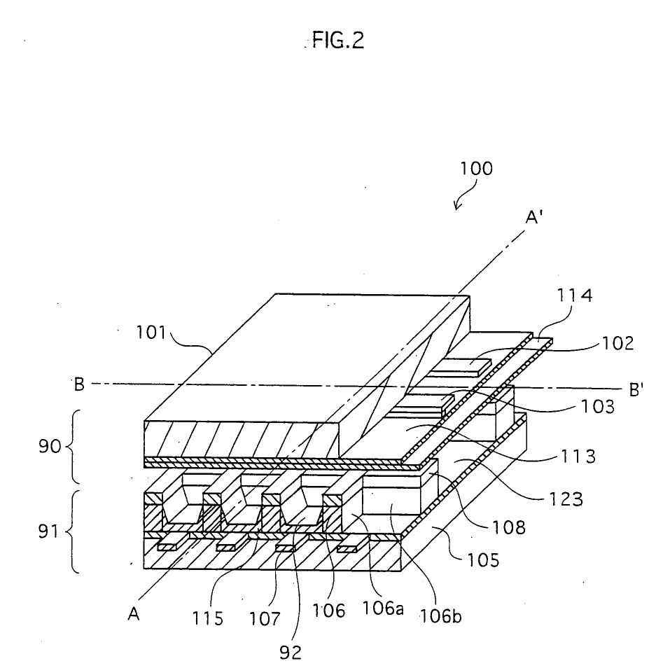

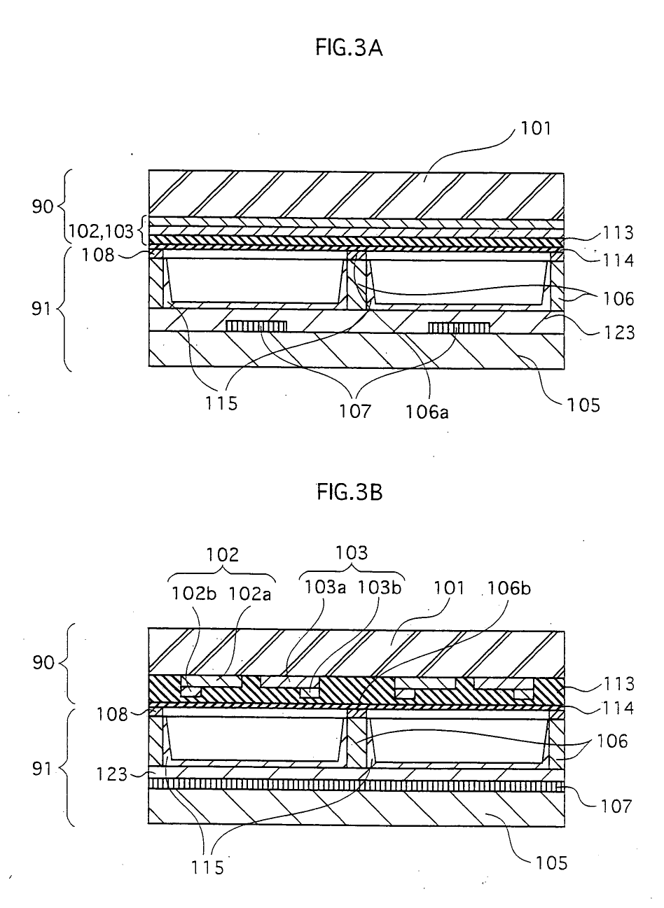

The following is the description of the structure of the panel unit 100 with reference to FIG. 2, FIG. 3A and FIG. 3B.

FIG. 2 is a perspective view which typically shows the configuration of the panel unit 100. FIG. 3A is a cross-sectional view of the panel unit 100 taken along the line B-B′, and FIG. 3B is a cross-sectional view of the panel unit 100 taken along the line A-A′.

As FIG. 1 shows, the panel unit 100 comprises the front plate 90 and the back plate 91 which are disposed so as to face each other's principal surface, and these plates are disposed one on top of another and sealed at peripheral edges of the plates with sealing glass (not shown in the figure) so that a discharge space 92 is formed between them.

The front plate 90 includes a front glass substrate 101, a scan electrode 102 as an example of the first electrode, a sustain electrode 103 as an example of the second electrode, a dielectric layer 113, and a protective layer 114.

The front glass substrate 101 is a substrate of the front plate 90. The scan electrode 102 and the sustain electrode 103 are disposed on the front glass substrate 101.

The scan electrode 102 and the sustain electrode 103 are formed in the following manner:

Conductive metal oxide, such as ITO. (Indium Tin Oxide), SnO₂, and ZnO is layered on the front glass substrate 101 with use of the sputtering method, the vacuum vapor deposition method, the CVD method, spraying method, or the like, and transparent electrodes 102a and 103a (shown in FIG. 3B) are formed by patterning the layers so as to have a certain width and certain intervals with use of lithography. Then, bus electrodes 102b and 103b are formed by layering silver (Ag) on the transparent electrodes 102a and 103a with use of techniques within public domain, such as the thick-film forming method.

The dielectric layer 113 is formed on the front glass substrate 101, on which the scan electrode and the sustain electrode 103 are formed, in the manner that the front glass substrate is covered with the dielectric layer 113. On the dielectric layer 113, the protective layer 102, which is made of magnesium oxide (MgO), is formed.

The back plate 91 includes a back glass substrate 105, an address electrode 107 as an example of a third electrode, a dielectric layer 123, a barrier rib 106, a guide electrode 108 as an example of a fourth electrode, and a phosphor layer 115 formed on the barrier rib 106. The phosphor layer 115 corresponds to one of red green and blue.

The barrier rib 106 is made of insulative material, a plurality of which form parallel crosses crossing at right angles. The barrier rib 106 is composed of a parallel part 106a, which is parallel to the address electrode 107 as FIG. 3A shows, and an orthogonal part 106b, which is at right angles to the address electrode 107 as FIG. 3B shows.

This barrier rib 106 is formed by the screen printing with use of a photomask, or by the sandblasting.

The guide electrode 108 is made of conductive material, a plurality of which form parallel crosses crossing at right angles. The guide electrode 108 is disposed on the top of the barrier rib 106.

The guide electrode 108 is disposed on the top of the barrier rib with use of techniques within public domain, such as the vacuum vapor deposition method and the thick-film forming method. The description of how to dispose the guide electrode is omitted here.

The display driving unit 200 evenly applies voltage of electropositive potential over the guide electrode 108.

The discharge space 92 is filled with a discharge gas which is composed of rare gases, such as He, Xe, and Ne.

The vicinity of an area where a pair of the scan electrode 102 and the sustain electrode 103 cross one address electrode 107 over the discharge space 92 corresponds to a cell that contributes to image display.

The above-described phosphor layer 115 is formed on the wall surface of the above-described barrier ribs.

The dielectric layers 113 and 123, which are included in the front plate 90 and the back plate 91 respectively, are formed by applying an organic binder including lead glass with a low melting point and bismuth glass with a low melting point, and baking the applied organic binder.

The protective layer 102 is a thin film made of Magnesium oxide (MgO).

1-2. The Configuration of the Display Driving Unit 200

The following is the description of the configuration of the display driving unit 200 in the PDP device 1000.

As FIG. 1 represents, the display driving unit 200 includes a data detection unit 210, a subfield conversion unit 220, a display control unit 240, a sustain driver 250, a scan driver 260, a data driver 270, and a constant voltage applying unit 280.

The data detection unit 210 detects image data (gradation values for each cell) of each picture from video data, which is inputted externally and indicates gradation values of each discharge cell included in the panel unit 100. Then, the data detection unit 210 sequentially transmits the detected data to the subfield conversion unit 220.

The detection of image data of each picture can be performed based on a vertical synchronous signal included in the video data.

The subfield conversion unit 220 includes a subfield memory 221. The subfield conversion unit 220 converts the image data transmitted from the data detection unit 210 into subfield data which is a group of binary data indicating ON or OFF of cells for gradational display. Then, the subfield data is to be stored in the subfield memory 221.

The subfield data is outputted to the data driver 270 under control of display control unit 240.

Synchronous signals, such as a horizontal synchronous signal (Hsync) and a vertical synchronous signal (Vsync) are inputted to the display control unit 240 in synchronization with the above-described video data.

The display control unit 240 outputs, based on the inputted synchronous signals, a timing signal to the data detection unit 210 for indicating timing for transmitting the image data, a timing signal to the subfield conversion unit 220 for indicating timing for writing/reading to/from the subfield memory 221, and timing signals to the sustain driver 250, scan driver 260, and data driver 270 for indicating timing for applying each pulse voltage.

The sustain driver 250 uses an integrated driver circuit within public domain, and is connected to a plurality of sustain electrodes 103 which is disposed on the front plate 90 included in the panel unit 100.

The sustain driver 250 applies, to a plurality of sustain electrodes 103, an initialization pulse, an address pulse (approximately +180V), and a sustain pulse which varies from OV to a predetermined voltage (+180V to +220V, preferably +200V) during an initialization period and a sustain period of each subfield for performing steady initialization discharge, sustain discharge, and erase discharge in all the discharge cells.

The scan driver 260 uses an integrated driver circuit within public domain, and is connected to a plurality of scan electrodes 102 which is disposed on the front plate 90 included in the panel unit 100.

The scan driver 260 applies, to each of a plurality of scan electrodes 102, an initialization pulse, an address pulse (approximately +100V), and a sustain pulse which varies from OV to a predetermined voltage (+180V to +220V, preferably +200V) during the initialization period, the address period, and the sustain period of each subfield for performing steady initialization discharge, address discharge, and sustain discharge in all the discharge cells.

The data driver 270 uses an integrated driver circuit within public domain (e.g. the integrated driver circuit described in FIG. 1 of the Japanese unexamined patent publication NO. 2002-287691), and is connected to each of a plurality of address electrodes 107 which is disposed on the back plate 91 included in the panel unit 100. The data driver 270 selectively applies, to a plurality of address electrodes 107, an address pulse which is OV or a predetermined voltage (+60V to +90V, preferably +75V) during the address period of each subfield for performing steady address discharge and sustain discharge in all the discharge cells.

The constant voltage applying unit 280 applies, to the guide electrode 108, a predetermined constant voltage (−150V to +220V, preferably +30V to +150V) during the driving.

With this driving method, the addressing is performed so as to form wall charges only in the cells which are to emit light with the discharge between the scan electrode 102 and the address electrode 107. Also, the light emission with the surface discharge is sustained by the discharge between the scan electrode 102 and its corresponding sustain electrode 103.

Adding to this, the charge transfer caused by the discharge between the scan electrode 102 and the sustain electrode 103 is kept in the area surrounded with the guide electrode 108. This is by the effect of repulsive force, which is formed in the vicinity of the guide electrode 108 by applying positive voltage to the guide electrode 108 which surrounds the scan electrode 102 and its corresponding sustain electrode 103. As a result, the charge transfers between adjacent cells are effectively prevented.

In other words, the cross talk is prevented because the adjacent cells are electrically, not physically, isolated from each other by the guide electrodes 108 disposed on the border of the adjacent cells.

Also, the discharge becomes stable by this driving method. As a result, an anomalous discharge and a failure of addressing are prevented as well.

Furthermore, the influence of the electric field over the address discharge between the scan electrode 102 and the address electrode 107 is reduced, because the guide electrode 108 is disposed on the top of the barrier rib 106, which is distant from the address electrode 107. As a result the state of the address discharge is kept well, and prevention of the cross talk and stabilization of the address discharge are realized at the same time.

Also, in the case where the intervals between cells are shorter than those of the conventional panel unit, the discharge is kept well as well. The effective area of the cell is broadened and a high-luminance, high-resolution display is realized with the above configuration.

Also, it becomes possible to provide electric charges from the guide electrode. A so-called black noise, which causes when the wall charge is not enough to discharge, can be prevented by the discharge from the guide electrode. As a result, high luminous efficiency can be realized.

In the first embodiment, a predetermined constant voltage (−150V to +220V, preferably +30V to +150V) is applied to the guide electrode 108, which is the fourth electrode, however, the cross talk is also prevented by earthing the fourth electrode, just as the earthing for keeping the isolation between electrodes of a semiconductor or the like, because the display electrodes in the adjacent cells are electrically isolated from each other.

Note that the guide electrode 108 of the panel unit 100 in the first embodiment is disposed on the top of the barrier rib 106, however, the guide electrode 108 may be disposed on the wall surface of the front plate 90 which faces to the top of the barrier rib 106.

In this case, the guide electrode 108 is disposed on the protective layer 114 so as to surround each cell by forming parallel crosses.

In other words, the guide electrode 108 as an example of the fourth electrode may be disposed, along the borders of cells, on the side of the front plate 90.

Also, the addressing with the conventional driving method for the AC type PDP with address discharge is available, because there is no metal part between the display electrode and the address electrode, unlike the conventional PDP 2000.

The Second Embodiment

2-1. The Structure of the Panel Unit 500 The following is a description of the panel unit 500 according to the second embodiment.

The difference between the above-described panel unit 100 according to the first embodiment and the panel unit 500 is only in the configuration of the back plate. The panel unit 500 is driven by the display driving unit 200 just as the PDP device 1000.

More specifically, in the panel unit 500, the guide electrode is disposed at a different position from that of the panel unit 100.

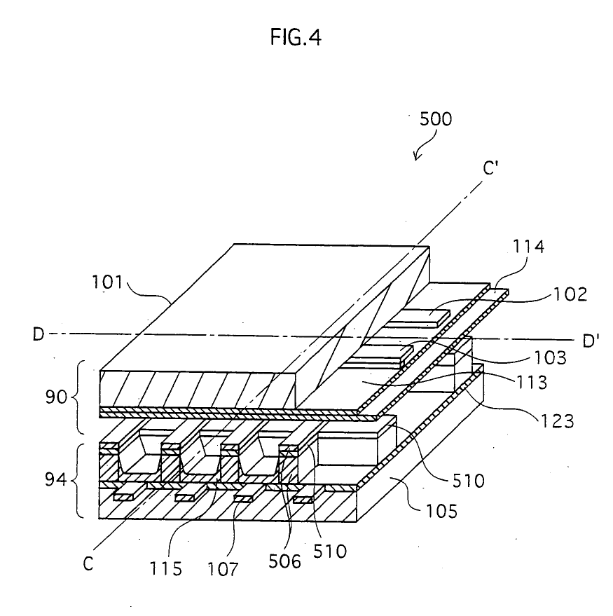

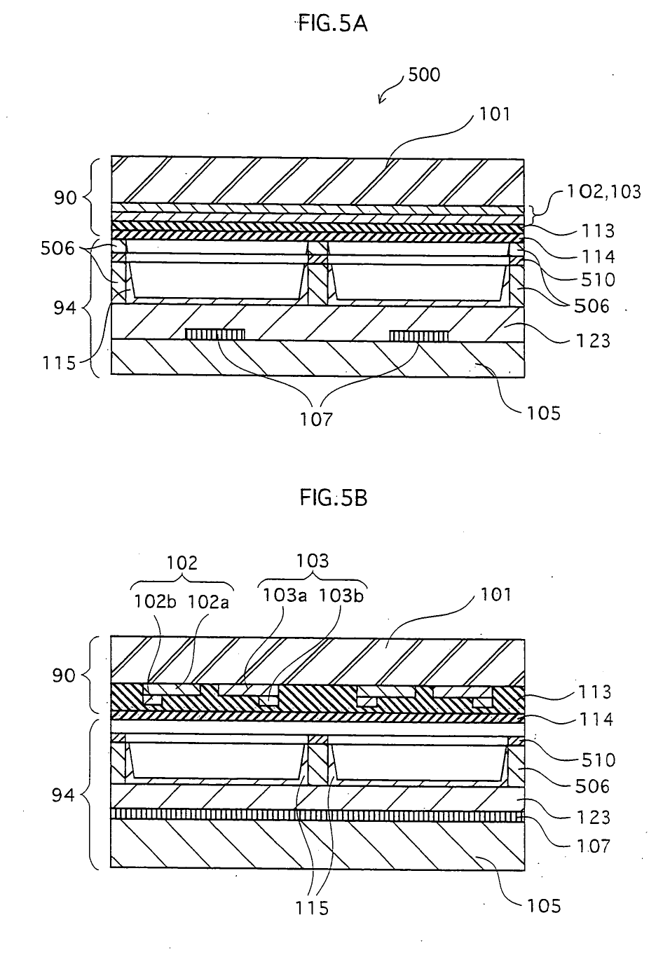

The following is a detailed description of the difference between the panel unit 500 and the panel unit 100, with reference to FIG. 4, FIG. 5A, and FIG. 5B.

FIG. 4 is a perspective view which typically shows the configuration of the panel unit 500. FIG. 5A is a cross-sectional view of the panel unit 500 taken along the line D-D′, and FIG. 5B is a cross-sectional view of the panel unit 500 taken along the line C-C′.

Note that in the panel unit 500, the parts which have same configuration as that of the panel unit 100 are indicated by the corresponding sings in the figures, and the description is omitted here.

As FIG. 4 shows, the back plate 94 is different from the back plate 91 in that the guide electrode 510 as an example of the fourth electrode is inserted in the barrier rib 506, not disposed on the top of the barrier rib. The insertion position is at a certain distance in the direction of height from the inside surface of the front plate 90, near the top of the barrier rib 506.

Here, “a certain distance in the direction of height from the inside surface of the front plate 90” means a distance which is not more than a half of the height of the barrier rib.

The guide electrode 510 is a electrode made of conductive material, a plurality of which form parallel crosses, just as the guide electrode 108 of the first embodiment.

Therefore, in the panel unit 500, the distance between the guide electrode 510 and the inside surface of the front plate 90 is longer than that in the panel unit 100.

Also, as FIG. 5A shows, a part of the barrier rib 606 which is parallel to the address electrode 107 substantially touches the inside surface of the front plate 90.

Here, “substantially touches” means that there may be no gap, or a very narrow gap.

Also, as FIG. 5B shows, between a part of the barrier rib 606 which is orthogonal to the address electrode 107 and the inside surface of the front plate 90, there is a wide gap.

This gap works as a flow path for releasing an impure gas.

The barrier rib 606 and the guide electrode 510 with the above-described configuration are formed in the following manner: Firstly, a barrier rib which is lower than the barrier rib 106 in the first embodiment is formed with use of the technique within public domain which is described in the first embodiment; Secondly, the guide electrode is formed by layering conductive materials on the top surface of the barrier rib; Finally, an insulative barrier rib is added onto the top of the guide electrode 510 with use of the above-described technique within public domain.

As described above, the panel unit 500 according to the second embodiment has the wide gap or the gas flow path between the part of the barrier rib 606 which is orthogonal to the address electrode 107 and the inside surface of the front plate 90. This gap brings benefit that the release of impure gases and filling of gasses are performed quickly.

Even in the case there is such a gap, the cross talk is prevented because there is the guide electrode 510 near the gap, which is applied a positive voltage.

Also, the state of the address discharge is kept well, and both prevention of the cross talk and stabilization of the address discharge are realized, just as in the first embodiment.

Furthermore, the guide electrode 510 is inserted in the barrier rib 503. The insertion position is at a certain distance from the inside surface of the front plate 90, near the top of the barrier rib 506. This means that the guide electrode 510 is distant from the address electrode 107. As a result, the influence of the electric field over the address discharge between the scan electrode 102 and the address electrode 107 is reduced, the state of the address discharge is kept well, and prevention of the cross talk and stabilization of the address discharge are realized at the same time.

Also, it becomes possible to provide electric charges from the guide electrode just as the panel unit 100 in the first embodiment. A so-called black noise, which causes when the wall charge is not enough to discharge, can be prevented by the discharge from the guide electrode. As a result, high luminous efficiency is realized.

Also, the addressing with the conventional driving method for the AC type PDP with address discharge is available, because there is no metal part between the display electrode and the address electrode unlike the conventional PDP 2000.

The Third Embodiment

3-1. The Structure of the PDP Device 1500

The following is a description of the AC type PDP device 1500 according to the third embodiment.

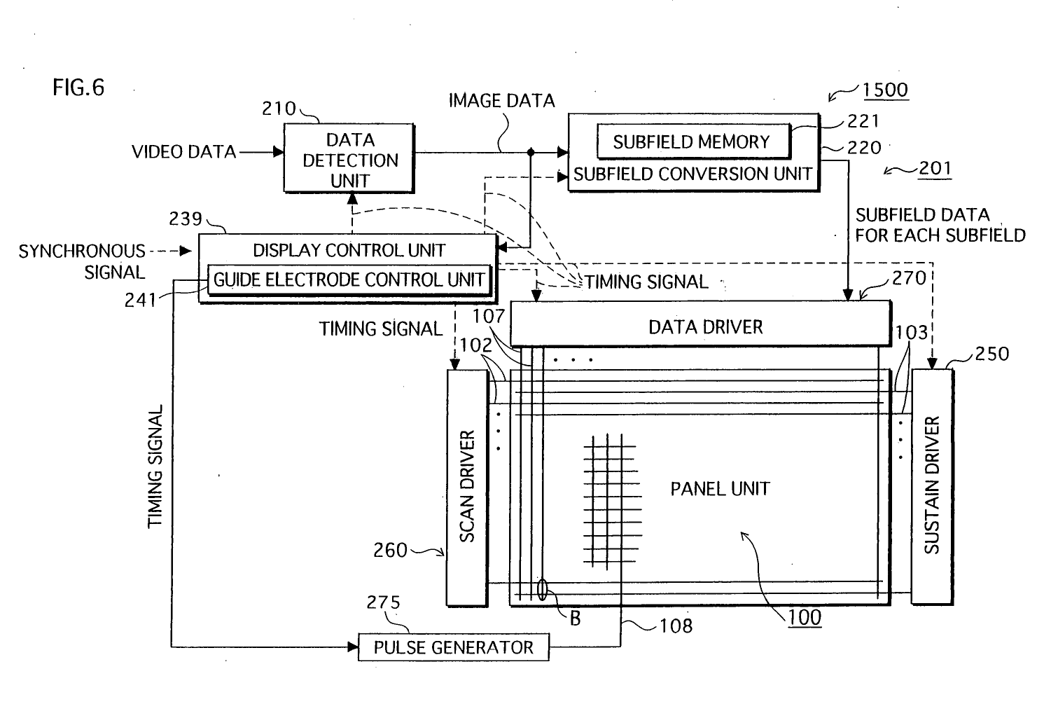

As FIG. 6 shows, the PDP device 1500 includes a panel unit 100 for displaying images, and a display driving unit 201 for driving the panel unit 100 based on the intra-field time division gradation display technique.

The display driving unit 201 is different from the display driving unit 200 of the first and second embodiment only in the manner of applying voltage to the guide electrode.

3-2. The Configuration of the Display Driving Unit 201

The following is a detailed description of the display driving unit 201.

Comparing the display driving unit 201 with the display driving unit 200, a display control unit 239, instead of the display control unit 240, is disposed in the display driving unit 201 as FIG. 6 shows.

Also, a pulse generator 275 is added between a guide electrode control unit 241 and the guide electrode 108.

The pulse generator 275 applies, to the guide electrode 108, a pulse voltage which varies from 0V to a predetermined voltage (−150V to +220V, preferably +30V to +150V) while receiving timing signals from the guide electrode control unit 241.

Also, in the case where the pulse generator 275 receives a signal which instructs the pulse generator 275 to apply a positive constant voltage to the guide electrode 108, the pulse generator 275 applies a positive constant voltage to the guide electrode 108.

The display control unit 239 includes the guide electrode control unit 241.

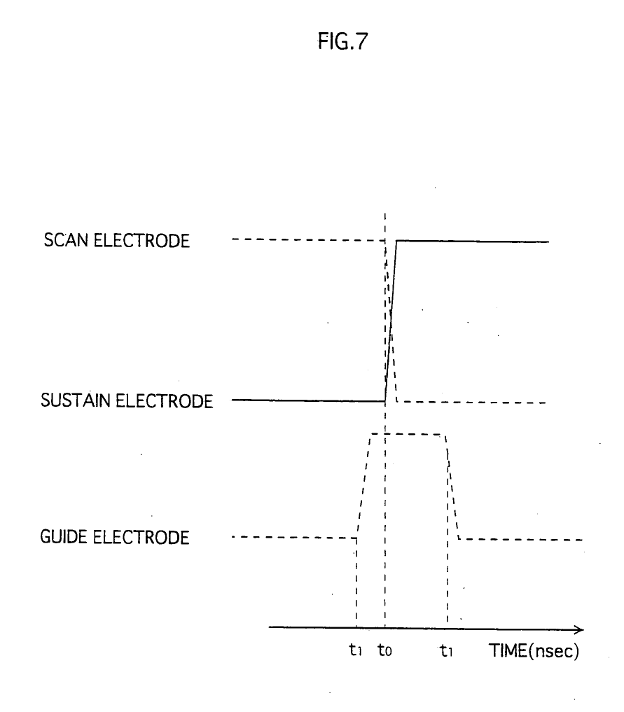

As FIG. 7 shows, the guide electrode control unit 241 outputs the timing signal to the pulse generator 275 so that a pulse applied to the guide electrode rises at t₋₁, which is 100 nsec before t₀, and falls at t₁, which is 100 nsec after t₀. Here, the sign t₀ represents a time when a pulse applied to the sustain electrode 103 rises up. The timing of this rising up is the same timing as a voltage V₁ applied to the scan electrode 102 (100V<V₁<300V) with a pulse width t_{w1 (}10 nsec<t_{w1} <1 μsec) falls down. The phase of the pulse applied to the sustain electrode 103 is completely opposite to that of the voltage V₁.

Also the guide electrode control unit 241 outputs, during the address period, a signal which instructs the pulse generator to apply a positive constant voltage to the guide electrode 108.

As described above, an AC discharge is caused by applying voltages to the guide electrode 108 and the scan electrode 102 alternately. Here, a voltage is applied to the guide electrode 108 so that the period in which the voltage pulse applied to the scan electrode 102 falls down and the period in which the voltage pulse applied to the sustain electrode 103 rises up overlap each other.

The negative charges are inductively accelerated by the guide electrode 108 which exist in the vicinity. This realizes a discharge with a low voltage and a driving with low electric power.

Also, a cross talk, an anomalous discharge, and a failure of addressing are prevented, because the adjacent display electrodes in the adjacent cells are electrically isolated from each other.

With the above configuration, the state of the discharge is improved just as the panel unit 100 in the first embodiment and the panel unit 500 in the second embodiment. In the case where the intervals between cells are shorter than those of the conventional panel unit, the discharge is kept well as well. The effective area of the cell is broadened and a high-luminance, high-resolution display can be realized.

Also, just as the panel unit 100 in the first embodiment and the panel unit 500 in the second embodiment.

Also the guide electrode 108 is distant from the address electrode 107 just as in the first embodiment and the second embodiment. As a result, the influence of the electric field over the address discharge between the scan electrode 102 and the address electrode 107 is reduced, the state of the address discharge is kept well, and prevention of the cross talk and stabilization of the address discharge are realized at the same time.

Note that in the PDP device 1500 of the third embodiment, the panel unit 100 is driven by the display driving unit 201, however, the panel unit 500 may be used instead of the panel unit 100, because both of them have the same basic characteristics and in both cases, prevention of a cross talk, an anomalous discharge, a failure of addressing, and so on is realized, and the light emission becomes more efficient.

Also note that the value of the time parameter which is set to the guide electrode control unit 241 and the value of the voltage parameter which is set to the pulse generator 275 are based on the common positional relation between cells of PDPs which are commercially available at present. Therefore, those values and the shape of the pulses waves may differ according to the cell size and the positional relation between the cells.

Also note that in the third embodiment, the guide electrode control unit 241 applies a signal which instructs the pulse generator 275 to apply a positive constant voltage to the guide electrode 108, however, the guide electrode control unit 241 may apply a signal which instructs the pulse generator 275 to earth the guide electrode 108 during the address period.

The Fourth Embodiment

4-1. The Configuration of the PDP Device 1600.

The following is a description of the AC type PDP device 1600 according to the fourth embodiment.

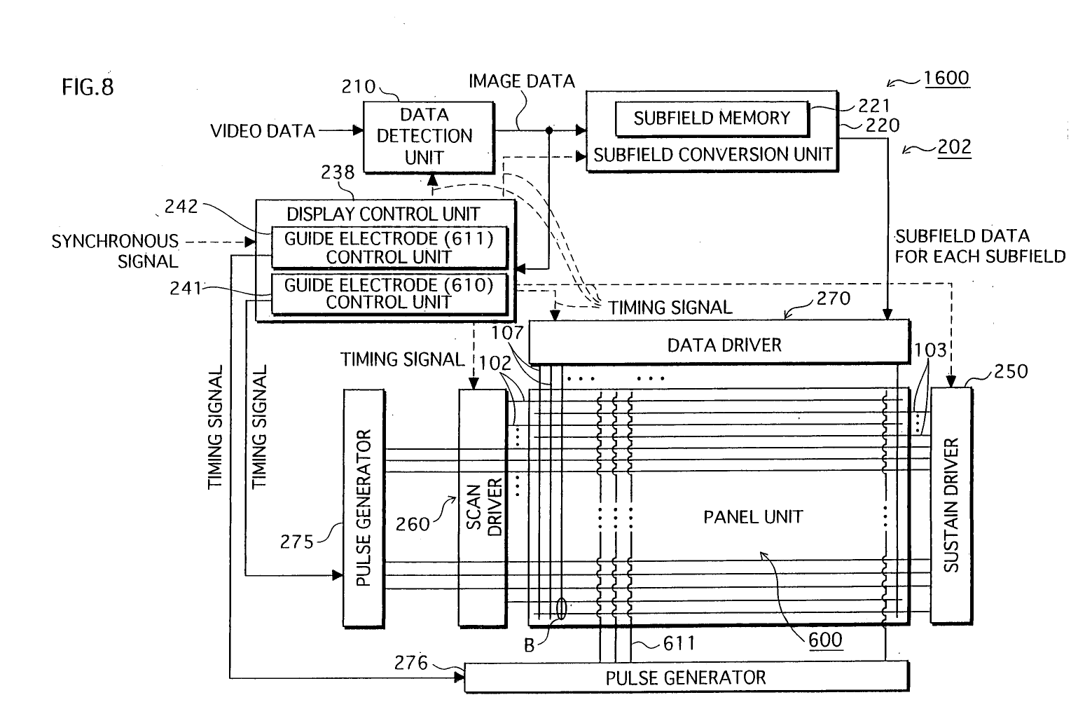

As FIG. 8 shows, the PDP device 1600 includes a panel unit 600 for displaying images, and a display driving unit 202 for driving the panel unit 600 based on the intra-field time division gradation display technique.

The PDP device 1600 in the fourth embodiment is different from the PDP device 1000 in the first embodiment in the configuration of the panel unit and the display driving unit.

The following is the difference between the PDP device 1600 and the PDP device 1000.

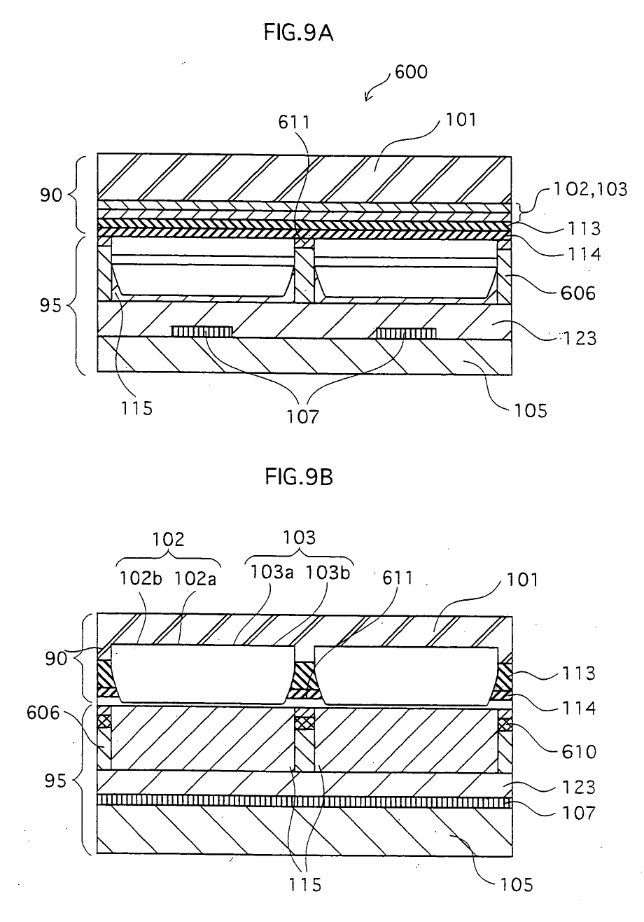

As FIG. 9A and FIG. 9B show, the panel unit 600 in the fourth embodiment is different from the panel unit 100 in the first embodiment in the configuration of the back plate.

More specifically, in the panel unit 600, two guide electrodes, which are different in direction, are disposed on the back plate 95. In this point, the panel unit 600 is different from the panel unit 100 and the panel unit 500.

As FIG. 9A and FIG. 9B show, a guide electrode 610 as an example of the fourth electrode is inserted in the barrier rib 606 so as to form right angles with the address electrode 107. The insertion position is at a certain distance in the direction of height from the inside surface of the front plate 90 (The position is near the front plate 90, and the case where the distance to the front plate 90 is zero is excluded). Also, the guide electrode 611 as an example of the fifth electrode, which is parallel to the address electrode 107, is disposed on the top of the barrier rib 606.

Here, “a certain distance in the direction of height from the inside surface of the front plate 90” means a distance which is not more than a half of the height of the barrier rib. There is a gap between the guide electrode 611 and the inside surface of the front plate 90, which works as a gas flow path.

Note that the guide electrodes 610 and 611 are disposed on the barrier rib 606 with use of the technique within public domain. Therefore, the description of how to dispose the guide electrodes is omitted here.

4-2 The configuration of the display driving unit 202 The following is a detailed description of the display driving unit 202.

As FIG. 8 shows, a guide electrode control unit 241 is added to the display control unit 240 included in the display driving unit 201.

Comparing the display driving unit 202 with the display driving unit 201, a display control unit 238, instead of the display control unit 239, is disposed in the display driving unit 202 as FIG. 8 shows.

Also, a pulse generator 276 is added between a guide electrode control unit 241 and the guide electrode 108.

The pulse generator 275 applies, to the guide electrode 610, a pulse voltage which varies from 0V to a predetermined voltage (−150V to +220V, preferably +30V to +150V) while receiving timing signals from the guide electrode control unit 241, and the pulse generator 276 applies, to the guide electrode 611, a pulse voltage which varies from 0V to a predetermined voltage (−150V to +220V, preferably +30V to +150V) while receiving timing signals from the guide electrode control unit 242.

The maximum value of the voltage which is applied to the guide electrode 611 is set to be less than the maximum value of the voltage which is applied to the guide electrode 610.

The operation of the guide electrode control unit 241 is the same as that described in the third embodiment.

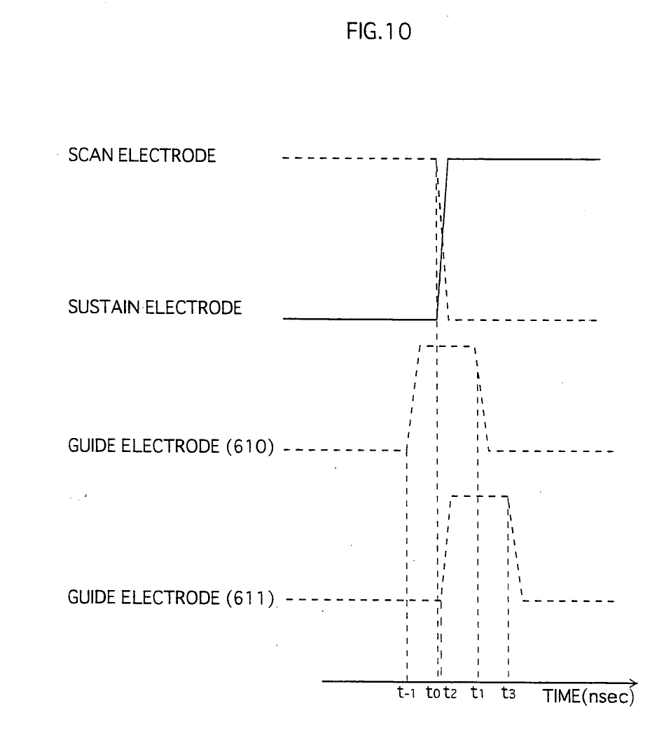

As FIG. 10 shows, the guide electrode control unit 242 outputs the timing, signal to the pulse generator 276 so that the rising timing of the pulse which is applied to the guide electrode 611 becomes t₂, which is 10 nsec to 1 μsec after the rising timing of the pulse which is applied to the guide electrode 610, and the falling timing of the pulse which is applied to the guide electrode 611 becomes t₃, which is 10 nsec to 1 μsec after the falling timing of the pulse which is applied to the guide electrode 610.

With the voltage pulse, which is applied to the guide electrode 611 based on the above-described control, the area in which the plasma discharge occurs is extended in the cells toward the back panel.

As described above, with the PDP device 1600 according to the fourth embodiment, more precise control can be performed by applying different voltage pulse to each of the guide electrodes, which are in the neighborhood of the inside surface of the front plate 90 and disposed on the facing two surfaces of four surfaces of the barrier ribs which surround each cell.

In other words, the pulse waveform and the timing of applying the pulse for removing the cross talks between cells and the anomalous discharges can be determined and applied to the guide electrode 610 which is disposed so as to form right angles with the address electrode 107, and the area in which plasma discharge occurs can be extended in the cells toward the back panel by the effect of guide electrode 611 which is disposed to be parallel to the address electrode107.

Also, the guide electrode 610 and the guide electrode 611 are distant from the address electrode 107 just as in the first, second, and third embodiment. As a result, the influence of the electric field over the address discharge between the scan electrode 102 and the address electrode 107 is reduced, the state of the address discharge is kept well, and prevention of the cross talk and stabilization of the address discharge are realized at the same time.

Note that the value of the time parameter which is set to the guide electrode control units 241 and 242, and the value of the voltage parameter which is set to the pulse generators 275 and 276 are based on the common positional relation between cells of PDPs which are commercially available at present. Therefore, those values and the shape of the pulse waves may differ according to the cell size and the positional relation between the cells.

Also note that in the panel unit 600 in the fourth embodiment, the guide electrode 611 as an example of the fifth electrode is disposed on the top of the barrier rib 606, however, the guide electrode 611 may be disposed on the wall surface of the front plate which faces to the top of the barrier rib 606.

In this case, the guide electrode 611 is formed on the top surface of two walls out of four, which surround each cell on the side of the front plate 90. The two walls are parallel to the display electrode.

Also, the addressing with the conventional driving method for the AC type PDP with address discharge is available, because there is no metal part between the display electrode and the address electrode, unlike the conventional PDP 2000.

### INDUSTRIAL APPLICABILITY

The present invention is applicable to high-resolution display devices used for televisions, computer displays, and the like.

1. A plasma display panel in which a plurality of pairs of first and second electrodes are disposed on a first substrate so as to be parallel to each other, a plurality of third electrodes are disposed on a second substrate, and main parts of a plurality of barrier ribs are disposed between adjacent third electrodes, the third electrodes being orthogonal to a longitudinal direction of display electrodes each of which consists of a pair of the first and second electrodes, wherein
a plurality of fourth electrodes are fixed to the barrier ribs or areas of a surface of the first substrate facing the barrier ribs so as to be at least in vicinities of areas between adjacent display electrodes, the fourth electrodes being electrically exposed to discharge spaces which are defined by the barrier ribs.

2. The plasma display panel of claim 1, wherein
the fourth electrodes are at a first distance from the first substrate, and fixed to the barrier ribs in such a manner as to be inserted in the barrier ribs or disposed on surfaces of the barrier ribs.

3. The plasma display panel of claim 2, wherein
the fourth electrodes are disposed on top of the barrier ribs.

4. The plasma display panel of claim 2, further comprising:
a plurality of fifth electrodes which are inserted in the barrier ribs at a second distance from the first substrate.

5. The plasma display panel of claim 4, wherein
sub-parts of the barrier ribs, which bridge adjacent main parts of the barrier ribs, are substantially orthogonal to the third electrodes,
the fourth electrodes are fixed to the main parts of the barrier ribs, and
the fifth electrodes are fixed to the sub-parts of the barrier ribs.

6. The plasma display panel of any of claim 1, wherein
sub-parts of the barrier ribs, which bridge adjacent main parts of the barrier ribs, are substantially orthogonal to the third electrodes.

7. A plasma display device in which a plurality of pairs of first and second electrodes are disposed on a first substrate so as to be parallel to each other, a plurality of third electrodes are disposed on a second substrate, and main parts of a plurality of barrier ribs are disposed between adjacent third electrodes, the third electrodes being orthogonal to a longitudinal direction of display electrodes each of which consists of a pair of the first and second electrodes, wherein
a plurality of fourth electrodes are fixed to the barrier ribs so as to be at least in vicinities of areas between adjacent display electrodes, the fourth electrodes being electrically exposed to discharge spaces which are defined by the barrier ribs, and
the plasma display device includes a driving circuit for applying a voltage to the fourth electrodes or for earthing the fourth electrodes.

8. The plasma display device of claim 7, wherein
the driving circuit applies a positive voltage to the fourth electrodes.

9. The plasma display device of claim 8, wherein
the fourth electrodes are at a first distance from the first substrate, and fixed to the barrier ribs in such a manner as to be inserted in the barrier ribs or disposed on surfaces of the barrier ribs.

10. The plasma display device of claim 9, wherein
the fourth electrodes are disposed on top of the barrier ribs.

11. The plasma display device of claim 10, wherein
the driving circuit applies a first voltage pulse and a second voltage pulse to the first electrodes and the second electrodes respectively, and additionally applies a third voltage pulse to the fourth electrodes.

12. The plasma display device of claim 11, further comprising:
a plurality of fifth electrodes which are inserted in the barrier ribs at a second distance from the first substrate, wherein
the driving circuit applies a fourth voltage pulse to the fifth electrodes when outputting the first voltage pulse and the second voltage pulse at the same time.

13. The plasma display device of claim 12, wherein
sub-parts of the barrier ribs, which bridge adjacent main parts of the barrier ribs, are substantially orthogonal to the third electrodes,
the fourth electrodes are fixed to the main parts of the barrier ribs, and
the fifth electrodes are fixed to the sub-parts of the barrier ribs.

14. The plasma display device of claim 7, wherein
sub-parts of the barrier ribs, which bridge adjacent main parts of the barrier ribs, are substantially orthogonal to the third electrodes.

15. The plasma display panel of claim 2, wherein
sub-parts of the barrier ribs, which bridge adjacent main parts of the barrier ribs, are substantially orthogonal to the third electrodes.

16. The plasma display panel of claim 3, wherein
sub-parts of the barrier ribs, which bridge adjacent main parts of the barrier ribs, are substantially orthogonal to the third electrodes.

17. The plasma display panel of claim 4, wherein
sub-parts of the barrier ribs, which bridge adjacent main parts of the barrier ribs, are substantially orthogonal to the third electrodes.

18. The plasma display device of claim 8, wherein
sub-parts of the barrier ribs, which bridge adjacent main parts of the barrier ribs, are substantially orthogonal to the third electrodes.

19. The plasma display device of claim 9, wherein
sub-parts of the barrier ribs, which bridge adjacent main parts of the barrier ribs, are substantially orthogonal to the third electrodes.

20. The plasma display device of claim 10, wherein
sub-parts of the barrier ribs, which bridge adjacent main parts of the barrier ribs, are substantially orthogonal to the third electrodes.

21. The plasma display device of claim 11, wherein
sub-parts of the barrier ribs, which bridge adjacent main parts of the barrier ribs, are substantially orthogonal to the third electrodes.
